(19) United States
(12) Patent Application Publication
(10) Pub. No.: US 2019/0093481 A1
(43) Pub. Date: Mar. 28, 2019

(54) METHOD OF MANUFACTURING BLADED RINGS FOR RADIAL TURBOMACHINES USING STOP ELEMENTS WITH LOCALISED WELDS; CORRESPONDING BLADED RING

(71) Applicant: EXERGY S.P.A., Bologna (IT)

(72) Inventors: Claudio SPADACINI, Verbania Suna (IT); Dario RIZZI, Bisuschio (IT)

(73) Assignee: EXERGY S.P.A., Bologna (IT)

(21) Appl. No.: 16/079,456

(22) PCT Filed: Feb. 23, 2017
(86) PCT No.: PCT/IB2017/051025

§ 371 Date: Aug. 23, 2018

(30) Foreign Application Priority Data
Feb. 29, 2016 (IT) 102016000021053

(51) Int. Cl. F01D 5/04; B23K 26/21; B23K 20/12; F01D 5/30

(52) U.S. Cl. CPC F01D 5/041; B23K 26/21; B23K 20/12; B23K 2101/001; F05D 2230/232; F05D 2230/64; F01D 5/3061

(57) ABSTRACT

A method for manufacturing bladed rings for radial turbomachines, including: assembling a first support ring with a second support ring, with a plurality of blades, with a first and second connecting ring, to make a bladed ring including the first and second support ring coaxial and axially spaced and the plurality of blades disposed equidistant from a central axis and interposed between the rings. The method includes joining a first end of each blade to the first connecting ring, joining a second end of each blade to the second connecting ring, fixing the first connecting ring to the first support ring and fixing the second connecting ring to the second support ring. The first support ring, second support ring, plurality of blades, first and second connecting rings are finished elements before assembling, meaning they present their final geometry and need no further machining and/or plastic deformations during and/or after assembly.

### FIELD OF THE INVENTION

The present invention relates to a method for manufacturing bladed rings for radial turbomachines and a bladed ring obtained with said method.

Radial turbomachine means a turbomachine in which the flow of the fluid with which it exchanges energy is directed in a radial direction for at least part of the path completed in the turbomachine itself. This radial part of the path is delimited by at least one bladed ring through which the fluid moves prevalently along a radial direction relative to a rotation axis of the rotor of the turbomachine.

A “bladed ring” comprises a plurality of blades disposed equidistant from a central axis and joined together by two or more concentric rings axially spaced from one another. The blades extend between two rings with their leading and trailing edges parallel or substantially parallel to the central axis. The bladed ring can have either the function of a stator (it is fixed relative to a casing of the turbomachine and its blades are stator blades) or a rotor (i.e. it rotates and its blades are rotor blades and thus the central axis is the rotation axis).

The present invention can be applied both to centrifugal radial (out-flow) turbomachines and centripetal (in-flow) ones. The present invention can be applied both to driving turbomachines (turbines) and operating ones (compressors). Preferably, but not exclusively, the present invention relates to expansion turbines. Preferably, but not exclusively, the present invention relates to an expansion turbine for the production of electrical and/or mechanical energy.

Preferably, but not exclusively, the present invention relates to expansion turbines used in energy production apparatus which exploit geothermal sources, preferably via a steam Rankine cycle or organic Rankine cycle (ORC).

### BACKGROUND OF THE INVENTION

Public document U.S. 911,663 illustrates a method for producing vane series for gas turbines, in particular of a radial type, which comprises first joining the ends of the vanes or blades with thin metal strips and then rigidly joining the thin metal strips to robust stiffening rings. The metal strips are first made as straight strips provided with perforations in which the ends of the blades are inserted and secured. The strips are then shaped into an arc or circumference. The blade ends are welded to the strips by means of a blow-pipe or electric voltaic arc. The metal strips are rigidly fixed to the stiffening rings of, for example by welding or bending. The projecting ends of the blades and other superfluous portions are then removed by machining.

Public document U.S. 933,379 illustrates a method for producing vane rings for a turbine, wherein the rings are made up of a series of blades secured to connecting strips and stiffening rings are provided for said connecting strips. Ends of the vanes are inserted into slots formed in the strips and secured to the same by welding with a blow-pipe or electric voltaic arc. The strips are first made as straight strips provided with the slots and then shaped into an arc or circumference. The method comprises forming projections/recesses on/in the strips and rings; they are configured to be connected to one another by swaging the edges of said projections or by distorting an additional interposed connecting element. The additional connecting element can be a drawn wire, soft steel, brass, copper or nickel.

Public document U.S. 968,862 illustrates a method for producing vane rings for turbines. Ends of the blades are inserted into channels formed in the rings and then welded thereto. The vane rings can be joined to supporting rings, for example by means of dovetail joints.

Public document U.S. Pat. No. 1,831,104 illustrates a method for the construction of bladed rings consisting of two or more axially spaced connecting rings and a plurality of blades between them. Each of the connecting rings has a plurality of grooves, for example of the dovetail type, which open axially inward and extend from a radially inner surface in a radial direction. The grooves extend partially through the material of the respective connecting ring to form blade retaining pockets. Each of the blades has heads at its ends, for example of the dovetail type, the heads being fitted into the aforesaid pockets on a radially inner side of the connecting rings. The heads are fixed in the grooves by folding over a flange against the heads themselves.

Public document WO 2014/064567, in the name of the present Applicant, illustrates a method for building centrifugal radial stages, wherein the first and second ends of each blade are connected to two respective support rings joining, by means of laser welding, at least a first semi-portion belonging to the respective end of the blade to a respective second semi-portion belonging to the respective support ring so as to form a resilient yielding connecting portion along a radial direction, and placing at least a stop portion belonging to the end of the blade facing, along the aforesaid radial direction, at least a stop element of the respective support ring. The resilient yielding connecting portion enables the stop portion to enter into contact with the stop element when the stage is subjected to the operating loads of the turbine.

Public document U.S. Pat. No. 5,586,864 illustrates an assembly of stator vanes for an axial turbine. This assembly comprises an outer ring provided with a groove formed along an inner surface thereof and adapted to receive a first locator ring. The assembly comprises an inner element provided with a second groove formed along an outer surface thereof and configured to receive a second locator ring. The locator rings have slots for fitting the stator blades.

Document FR1330735 illustrates a method for constructing a bladed assembly for turbines, wherein the blades are welded onto a support ring.

Document U.S. Pat. No. 1,717,203 illustrates a method for manufacturing a bladed turbine structure, wherein the blades have projections engaged in notches formed in connecting strips inserted respectively in an outer ring and an inner ring.

Document GB 732,919 illustrates a bladed assembly for turbomachines, such as compressors and turbines, comprising an inner wall, which delimits the fluid passage, and an outer wall disposed radially outside the inner wall. Slots are formed in the inner and outer walls and said slots receive radially external ends of the blades. A wire acting as a lock extends through openings formed in the blade tips.

Document US 2014/147262 illustrates a stator assembly of an axial turbomachine. The stator assembly comprises an inner shell formed of a plurality of annular segments provided with a plurality of openings through which the stator blade tips are inserted. An annular metal strip passes through openings defined by hooks formed on the blade tips to restrain said blades radially.

### SUMMARY

In this context, the Applicant has perceived the need to improve the quality and constructive precision of the bladed rings of a known type and thus the reliability and efficiency of the turbomachines in which they are installed.

The Applicant has in fact noted that bladed rings such as those disclosed in documents U.S. 911,663 and U.S. 933,379, which are composed of a number of parts that are later assembled, cannot be very precise geometrically because during assembly of the individual parts, such parts are subjected to mechanical stresses due to machining processes and/or high temperatures such as to alter their shape and they must necessarily undergo a final re-machining.

For example, in U.S. 911,663 the metal strips intended to connect the blades to the stiffening rings are welded to the blades by means of a blow-pipe or electric voltaic arc. In one embodiment the metal strips and stiffening rings are also joined by welding by means of a blow-pipe or electric voltaic arc. The heat input in this manner can alter the mechanical characteristics and shape of the blades and/or the position/orientation thereof relative to strips to which they are connected. After being connected with the blades, the strips are moreover machined to remove the excess material. In a different embodiment disclosed in U.S. 911,663, the metal strips are rigidly secured to the stiffening rings by bending/distorting parts thereof. These processes, too, can alter the geometric design characteristics.

In U.S. 933,379, in addition to the blades being joined to the strips by welding with a blow-pipe or electric voltaic arc, the swaging of the edges of the projections and distortion of the additional connecting element do not enable precise control of the final geometric characteristics of the bladed ring thus obtained.

The Applicant has also noted that the connection systems such as the ones just commented on or the one disclosed in document U.S. Pat. No. 1,831,104 are poorly able to withstand the thermal gradients which occur, for example, in the start-up transients. During these transients, the high-temperature steam impacts only the blades and some portions of the turbomachine casing. Heat then spreads from the parts impacted by the steam towards the other parts of the turbomachine. The blades and rings expand in a different manner and the assembly tends to lose its strength. This phenomenon is more critical in rotor bladed rings which are subjected to centrifugal force.

The Applicant has also noted that in solutions which envisage constructing rotor bladed rings by directly joining the blades and support rings, as in WO 2014/064567 and U.S. 968,862 (i.e. without intermediate metal strips or connecting rings), it proves to be more difficult to separate the stresses due to centrifugal force from those due to the weight of the blades. In particular, the Applicant has noted that the internal circumferential stresses due to centrifugal force have points of maximum concentration in the areas of connection with the blades, in particular at the trailing edges thereof. These areas of maximum concentration of the stresses are structurally dangerous.

The Applicant has thus set itself the following objectives:
to propose a method for manufacturing bladed rings which serves to improve the quality and precision thereof and hence the reliability and efficiency of the turbomachines in which they are installed;
to propose a method for manufacturing bladed rings which is fast and relatively simple;
to propose a method for manufacturing bladed rings which is repeatable and controllable;
to propose a method for manufacturing bladed rings which can be completely automated;
to propose a method for manufacturing bladed rings which does not require, after or during assembly, intermediate machining of the parts composing the bladed ring itself;
to propose a bladed ring in which the concentrations of stresses are limited.

The Applicant has found that the objectives specified above and still others can be achieved by individually producing three types of elements composing the bladed ring (namely: blades, support rings and connecting rings, as described further below) in the their final form and then assembling said elements by means of joining systems that alter neither the geometry nor the structural properties thereof, so that no intermediate or post-assembly machining is required.

In particular, the specified objectives and still others are substantially reached by a turbomachine according to one or more of the appended claims and/or in accordance with one or more of the following aspects.

In the present description and in the appended claims, the adjective “axial” is meant to define a direction directed parallel to a central or rotation axis of “X-X” of the turbomachine. The adjective “radial” is meant to define a direction directed like radii extending orthogonally from the central or rotation axis “X-X” of the turbomachine. The adjective “circumferential” means directions tangent to circumferences coaxial with the central or rotation axis “X-X” of the turbomachine. More specifically, according to an independent aspect, the present invention relates to a method for manufacturing bladed rings for radial turbomachines.

The method comprises: preparing a first support ring; preparing a second support ring; preparing a plurality of blades; preparing a first connecting ring or first connecting arched sectors; preparing a second connecting ring or second connecting arched sectors.

The method comprises: assembling the first support ring with the second support ring, with the plurality of blades, with the first connecting ring or with the first connecting arched sectors and with the second connecting ring or with the second connecting arched sectors, so as to make a bladed ring comprising the first and the second support ring coaxial and axially spaced from one other and the plurality of blades disposed equidistant from a central axis and interposed between said first and second support ring. The blades have a leading edge substantially parallel to the central axis.

Assembling comprises: stably joining a first end of each blade to the first connecting ring or to one of the first connecting arched sectors; stably joining a second end of each blade to the second connecting ring or to one of the second connecting arched sectors; fixing the first connecting ring or the first connecting arched sectors to the first support ring; fixing the second connecting ring or the second connecting arched sectors to the second support ring.

Stably joining comprises: performing, preferably by means of laser welding or friction stir welding, localized welds placed between the first ends and the first connecting ring (or the first connecting arched sectors) and placed between the second ends and the second connecting ring (or the second connecting arched sectors); or interposing at least a first stop element between the first ends and the first connecting ring, or the first connecting arched sectors, and at least a second stop element between the second ends and the second connecting ring, or the second connecting arched sectors.

Preferably but not necessarily, fixing comprises: performing, preferably by means of laser welding or friction stir welding, localized welds placed between the first support ring and the first connecting ring or the first connecting arched sectors and placed between the second support ring and the second connecting ring, or the second connecting arched sectors.

Said first support ring, second support ring, plurality of blades, first connecting ring or first connecting arched sectors, second connecting ring or second connecting arched sectors, are all finished elements before assembling, meaning that they present their final geometry and they do not need further machining and/or permanent plastic deformations during and/or after said assembling.

“Localized weld” means a weld with narrow beads, typically of a width that is smaller than the bead depth, preferably less than 4 mm, preferably less than 2 mm, and with very limited heat affected zones, typically with a width smaller than said bead depth.

The Applicant has verified that the particular joints adopted both to constrain the blades to the connecting rings and to constrain the connecting rings to the support rings do not alter the structure of the individual starting elements (blades, support rings and connecting rings) and make it possible to obtain a very well-defined geometry of the assembly without performing intermediate or subsequent re-machining of the bladed ring. Laser welding and friction stir welding do not in fact entail the use of further material and introduce very localized heat that does not result in deformations such as to require re-machining, in particular of the weld itself and/or parts close to the weld. Laser welding has a high power density (approximately 1 MW/cm²), resulting in small heated zones with a high rate of heating and cooling. More in particular, laser welding is characterized by the following properties: narrow beads with very limited heat-affected zones, a very important characteristic for stainless steel in order to prevent the precipitation of chrome carbides; speed of execution usually faster than is obtainable with traditional techniques; increase in the possibility of automation; excellent reproducibility (2% per P<5 kW); absence of contact between part and electrode; rapid joint cooling, which is likewise very important for stainless steel, since it prevents grain enlargement in the heat-affected zone in the metallographic structure, especially in ferritic stainless steels; low heat inputs; less deformations, weld shrinkage and joint distortions; less severe gripping systems; greater possibilities of welding heterogeneous materials, typically stainless steel with carbon steel; possibility of reaching zones that are not easily accessible; possibility of welding already treated and finished components; high repeatability and ease of automation of the welding operation, with associated online control; possibility of visual and acoustic inspection of the joint during the welding operation to ensure proper execution; and very high weld quality in terms of metallurgical and mechanical properties. The latter characteristic is obtainable thanks to the creation, in the melting zone, of a modification in chemical composition due to a preferential heating with vaporization of the impurities as a result of their higher absorption coefficient.

Friction stir welding (FSW) is a type of solid-state friction welding in which the melting temperature is not reached in the material to be welded. The weld bead is formed by a cylindrical tool. The tool has a pin in the terminal part which can have a thread. The pin, by rotating, generates friction, and thus heat. The latter renders the material plastic, and when it re-crystallizes it joins the two workpieces. FSW is a welding process in which the material is not brought to a melting point. Thanks to this fact, one avoids many problems of a metallurgical nature tied to phenomena which occur during solidification. Furthermore, many of the drawbacks typical of traditional welding processes, such as the emission of fumes, the presence of electric arcs and sprays and noise pollution, do not occur. FSW makes it possible to obtain joints of excellent quality and efficiency, characterized by low internal tensions and deformations, while nonetheless maintaining very high productivity, as it enables workpieces of a large thickness to be welded in a single pass. To these advantages one may add the possibility of welding light alloys that are traditionally not weldable and materials that are analogous or dissimilar in chemical composition and the state in which they are supplied. The advantages deriving therefrom are: minimal distortion of the material, clean process (absence of fumes, radiations, arcs, liquid metals and high voltages) and absence of contamination of the material, high joint strength, versatility of the process and possibility of welding a vast range of materials.

The alternative solution with locking elements of a mechanical type does not entail any type of appreciable deformation of the starting elements. In contrast, traditional welding processes with a blow-pipe or electric voltaic arc, such as those illustrated in the prior patents cited above, are carried out with solder material and bring large portions of the elements that need to be welded together to high temperatures.

The Applicant has also verified that the method according to the invention can be completely automated, thus considerably reducing the costs of producing the rings and thus of the rotors and stators (in particular those provided with many bladed rings) and of the turbomachine comprising them. Therefore, the present method is particularly advantageous for manufacturing bladed rings for single- and counter-rotating radial steam turbines, which can have tens of stator and/or rotor bladed rings.

The Applicant has further verified that the presence of the connecting rings (i.e. the absence of a direct joint between the blades and the support rings), which have a distinctly lower circumferential rigidity than is offered by the support rings, makes it possible to separate the stresses due to centrifugal force from those due to the weight of the blades and generated at that moment thereby at their roots. In this manner, the joints between the blades and connecting rings are not subject to circumferential stress, because the connecting ring is more yielding and rests against the respective support ring. An excessive concentration/intensification of stresses in the joint (weld or mechanical lock) between the connecting ring and the blades is thus avoided. The bladed ring can thus be subjected to higher peripheral speeds.

According to a different independent aspect, the present invention relates to a bladed ring for turbomachines, comprising:
a first support ring;
a second support ring coaxial with the first support ring and axially spaced from said first support ring;
a plurality of blades disposed equidistant from a central axis and interposed between said first support ring and second support ring, wherein the blades have a leading edge substantially parallel to the central axis;
a first connecting ring or first connecting arched sectors axially interposed between the first support ring and the blades;
a second connecting ring or second connecting arched sectors axially interposed between the second support ring and the blades;
wherein first ends of said blades are joined to the first connecting ring or to one of the first connecting arched sectors and second ends of said blades are joined to the second connecting ring or to one of the second connecting arched sectors by means of localized welds of the laser or friction stir welding type; or wherein the first ends of said blades are joined to the first connecting ring or to one of the first connecting arched sectors and the second ends of said blades are joined to the second connecting ring or to one of the second connecting arched sectors by means of at least a first stop element placed between the first ends and the first connecting ring or the first connecting arched sectors and at least a second stop element placed between the second ends and the second connecting ring or the second connecting arched sectors;
wherein the first connecting ring or the first connecting arched sectors is/are fixed to the first support ring and the second connecting ring or the second connecting arched sectors is/are fixed to the second support ring by means of localized welds of the laser or friction stir welding type.

According to a different aspect, the present invention relates to a stator or a rotor for radial turbomachines comprising at least one bladed ring in accordance with the invention and/or manufactured according to the method of the invention.

According to a different aspect, the present invention also relates to a radial turbomachine comprising at least one bladed ring in accordance with the invention and/or manufactured according to the method of the invention. Preferably, said radial turbomachine is a single-rotating or counter-rotating centrifugal radial turbine, i.e. provided with two reciprocally facing rotors rotating in opposite directions.

Further aspects of the invention are described here below.

Preferably, the blades are made by extrusion, considerably reducing costs. The blades are preferably obtained from an extruded rod that is then cut. Each blade is thus a straight cylinder that has an airfoil profile as a directrix and a straight line as a generatrix. This procedure enables considerable savings in terms of cost (it costs about 1/10 of a blade machined from a solid) and machining times and it can be easily automated.

Preferably, the connecting rings or the connecting arched sectors are formed from sheets or by calendaring of rings or by forging. Preferably, the connecting rings are perforated in their profile to obtain first and second slots for ends of the blades.

Preferably, the perforation is performed with laser cutting, water-jet cutting or electrical discharge machining.

Preferably, the support rings are formed by forging.

Preferably, the first connecting ring or the first connecting arched sectors has/have a plurality of first slots (the same number as the blades), preferably through slots which extend axially. Preferably, the second connecting ring or the second connecting arched sectors has/have a plurality of second slots (the same number as the blades), preferably through slots which extend axially.

Preferably, the first connecting ring or the first connecting arched sectors has/have a plurality of first radial through cavities each open into one of the first slots.

Preferably, the first radial through cavities are formed in a radially inner portion of the first ring or of the first connecting arched sectors. Preferably, the second connecting ring or the second connecting arched sectors has/have a plurality of second radial through cavities each open into one of the second slots. Preferably, the second radial through cavities are formed in a radially inner portion of the second ring or of the second connecting arched sectors.

Preferably, the first radial through cavities and the second radial through cavities open onto a radially inner surface respectively of the first connecting ring or of the first connecting arched sectors and of the second connecting ring or of the second connecting arched sectors.

Preferably, stably joining comprises: axially inserting the first ends into first slots formed in the first connecting ring, or in the first connecting arched sectors, to radially align first radial through cavities formed in the first connecting ring, or in the first connecting arched sectors, and open into the first slots with first seats formed in the first ends; radially inserting said at least a first stop element into the first radial through cavities and into the first seats in such a way as to prevent axial displacements.

Preferably, stably joining comprises: axially inserting the second ends into second slots formed in the second connecting ring, or in the second connecting arched sectors, to radially align second radial through cavities formed in the second connecting ring, or in the second connecting arched sectors, and open into the second slots with second seats formed in the second ends; radially inserting said at least a second stop element into the second radial through cavities and into the second seats in such a way as to prevent axial displacements.

The first and second stop elements perform the function of pins which prevent a relative axial displacement between the connecting rings and the blades.

Preferably, said at least a first stop element is a first locking ring. Preferably, the first radial through cavities together form a first circumferential cavity housing the first locking ring.

Preferably, said at least a second stop element is a second locking ring.

Preferably, the second radial through cavities together form a second circumferential cavity housing the second locking ring.

Preferably, the first and the second connecting ring are open-ended rings of the Seeger type. Preferably, the first and second connecting rings are obtained from caulking material that is driven inside said first and second radial through cavities and inside said first and second seats.

Preferably, the first radial through cavities form as many first cavities shaped like the arc of a circle, each in a first connecting arched sector. Preferably, the second radial through cavities form as many second cavities shaped like the arc of a circle, each in a second connecting arched sector.

Preferably, stably joining comprises: axially inserting the first ends into first slots formed in the first connecting ring or in the first connecting arched sectors and welding the first ends in said first slots.

Preferably, stably joining comprises: axially inserting the second ends into second slots formed in the second connecting ring or in the second connecting arched sectors and welding the second ends in said second slots.

Preferably, the welding of the first ends in the first slots is performed in terminal portions of said first slots facing the first support ring. Preferably, the welding of the second ends in the second slots is performed in terminal portions of said second slots facing the second support ring.

Preferably, the first and the second ends of each blade have a different shape relative to a profile of the same blade. Preferably, said shape forms a sort of peg with a non-circular cross section. Preferably, said shape has at least two opposite flat parallel surfaces. Preferably, the first slots and second slots are of mating shape at the respective first and second ends.

Preferably, the first ends have a first radially outer coupling surface, preferably flat.

Preferably, the second ends have a second radially outer coupling surface, preferably flat. Preferably, radially inserting said at least a first stop element implies pushing the first coupling surface against a coupling surface of the first slot. Preferably, radially inserting said at least a second stop element implies pushing the second coupling surface against a coupling surface of the second slot. Preferably, the first support ring has a first recess or a first projection that extends circumferentially, continuously or intermittently. Preferably, the second support ring has a second recess or a second projection that extends circumferentially, continuously or intermittently. The first and second recesses or projections are formed on respective faces of the first and second support rings, which are facing each other when the bladed ring is assembled.

Preferably, fixing comprises axially inserting and at least in part the first connecting ring or the first connecting arched sectors into a first recess formed in the first support ring. Preferably, said insertion serves to close said at least a first stop element in the first through cavities. Preferably, fixing comprises axially inserting and at least in part the second connecting ring or the second connecting arched sectors into a second recess formed in the second support ring. Preferably, said insertion serves to close said at least a second stop element in the second through cavities.

The first and the second radial through cavities are thus closed on the radially inner surface, respectively of the first connecting ring or of the first connecting arched sectors and of the second connecting ring or of the second connecting arched sectors, by the respective first or second support ring. The radial movement of the locking elements housed in the radial through cavities and in the seats is thus prevented.

Preferably, the weld(s) of the first ends and the weld(s) of the second ends remain(s) inside said first and second recess, i.e. protected inside the first or second support ring.

Preferably, it is envisaged to couple a first radially inner/outer circumferential abutment surface of the first support ring with a radially outer/inner centring surface of the first connecting ring or of the first connecting arched sectors.

Preferably, it is envisaged to couple a second radially inner/outer circumferential abutment surface of the second support ring with a radially outer/inner centring surface of the second connecting ring or of the second connecting arched sectors.

In this manner, if the bladed ring is a rotor, the first/second connecting ring or the first/second connecting arched sectors are pushed outward, by virtue of the centrifugal force, and rest against the respective support ring.

Alternatively, it is envisaged to couple a first radially inner/outer circumferential abutment surface of the first support ring with a radially outer/inner centring surface belonging to the first ends of the blades. Analogously, it is envisaged to couple a first radially inner/outer circumferential abutment surface of the first support ring with a radially outer/inner centring surface belonging to the second ends of the blades.

Preferably, the radially outer centring surface of the first connecting ring or of the first connecting arched sectors and the radially outer/inner centring surface of the second connecting ring or of the second connecting arched sectors are opposed to the radially inner surface respectively of the first connecting ring or of the first connecting arched sectors and of the second connecting ring or of the second connecting arched sectors onto which the radial through cavities open.

Preferably, the first support ring has a first annular central body and a radially inner annular portion and a radially outer annular portion projecting axially from said first annular central body and radially spaced and delimiting, together with the first annular central body, the first annular recess. Preferably, the second support ring has a second annular central body and a radially inner annular portion and a radially outer annular portion projecting axially from said second annular central body and radially spaced and delimiting, together with the first annular central body, the second annular recess.

Preferably, the first support ring has a radially outer annular appendage which projects from the first annular central body and externally surrounds the radially outer annular portion and a radially inner annular appendage which projects from the second annular central body and extends internally relative to the radially inner annular portion. Preferably, the second support ring has a radially outer annular appendage which projects from the second annular central body and externally surrounds the radially outer annular portion and a radially inner annular appendage which projects from the second annular central body and extends internally relative to the radially inner annular portion.

Preferably, the first annular connecting ring has a radially outer tubular body and a radially inner tubular body. Preferably, the second annular connecting ring has a radially outer tubular body and a radially inner tubular body.

Preferably, localized welds (laser or FSW) are performed, preferably butt welds, between every radially outer annular appendage and the respective radially outer tubular body and between every radially inner annular appendage and the respective radially inner tubular body.

This connection (between the annular appendages and tubular bodies), under the action of the centrifugal force (if the bladed ring is a rotor), permits an outward radial bending of the annular appendages and/or the tubular bodies such as to permit the centring surfaces of the connecting rings to rest against the circumferential abutment surfaces of the support rings.

Additional features and advantages will become more apparent from the detailed description of preferred, but not exclusive, embodiments of a bladed ring for radial turbomachines and of methods for the manufacture thereof according to the present invention.

### DESCRIPTION OF THE DRAWINGS This description will be given below with reference to the attached drawings, provided solely for illustrative and therefore non-limiting purposes, in which:

FIG. 1 illustrates a meridian section of a radial turbomachine comprising bladed rings according to the present invention;

FIG. 2 is a partial cutaway perspective view of one of the bladed rings of FIG. 1;

FIG. 3 is a sectional view in a radial plane of a portion of the bladed ring of FIG. 2;

FIG. 3A is a side view of the blade illustrated in FIG. 3;

FIG. 4 is a sectional view in a radial plane of a portion of a different embodiment of the bladed ring of FIG. 3;

FIG. 4A is a side view of the blade illustrated in FIG. 4;

FIG. 5 is a sectional view in a radial plane of a portion of a variant of the bladed ring of FIG. 4;

FIG. 5A is a side view of the blade illustrated in FIG. 5;

FIG. 6 is a sectional view in a radial plane of a portion of a further variant of the bladed ring of FIGS. 4 and 5; and

FIG. 6A is a side view of the blade illustrated in FIG. 6.

### DETAILED DESCRIPTION

With reference to the aforementioned figures, the reference number 1 denotes in its entirety a radial turbomachine.

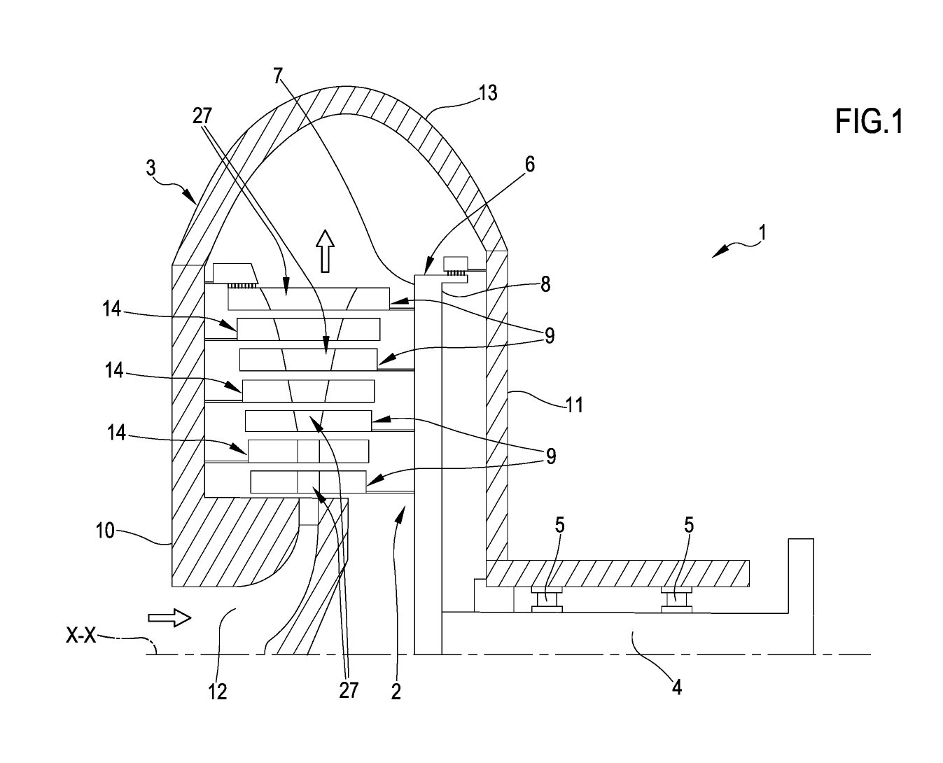

The radial turbomachine 1 illustrated in FIG. 1 is an expansion turbine of the centrifugal radial type with a single rotor 2. For example, the turbine 1 can be employed in the field of electricity generating plants of the Organic Rankine Cycle (ORC) or steam Rankine cycle which exploit geothermal resources as a source.

The turbine 1 comprises a fixed casing 3 in which the rotor 2 is housed in such a way as to be able to rotate. For this purpose the rotor 2 is rigidly connected to a shaft 4 that extends along a central axis “X-X” (which coincides with a rotation axis of the shaft 4 and rotor 2) and is supported in the fixed casing 3 by appropriate bearings 5. The rotor 2 comprises a rotor disk 6 directly connected to the aforesaid shaft 4 and provided with a front face 7 and an opposite rear face 8. The front face 7 supports a plurality of projecting rotor bladed rings 9 which are concentric and coaxial with the central axis “X-X”.

The fixed casing 3 comprises a front wall 10, placed opposite the front face 7 of the rotor disk 6, and a rear wall 11, located opposite the rear face 8 of the rotor disk 6. The front wall 10 has an opening defining an axial inlet 12 for a working fluid. The axial inlet 12 is located at the central axis “X-X” and is circular and concentric with the same axis “X-X”. The fixed casing 3 further has a spiral pathway 13 for the working fluid located in a peripheral position radially external to the rotor 2 and in fluid communication with an outlet, not illustrated, of the fixed casing 3.

The front wall 10 supports a plurality of projecting stator bladed rings 14 which are concentric and coaxial with the central axis “X-X”. The stator bladed rings 14 extend inside the casing 3 towards the rotor disk 6 and alternate radially with the rotor bladed rings 9 so as to define a radial expansion path for the working fluid which enters through the axial inlet 12 and expands as it moves away radially towards the periphery of the rotor disk 2 until entering the spiral pathway 13 and then exiting the fixed casing 3 through the aforesaid outlet, not illustrated.

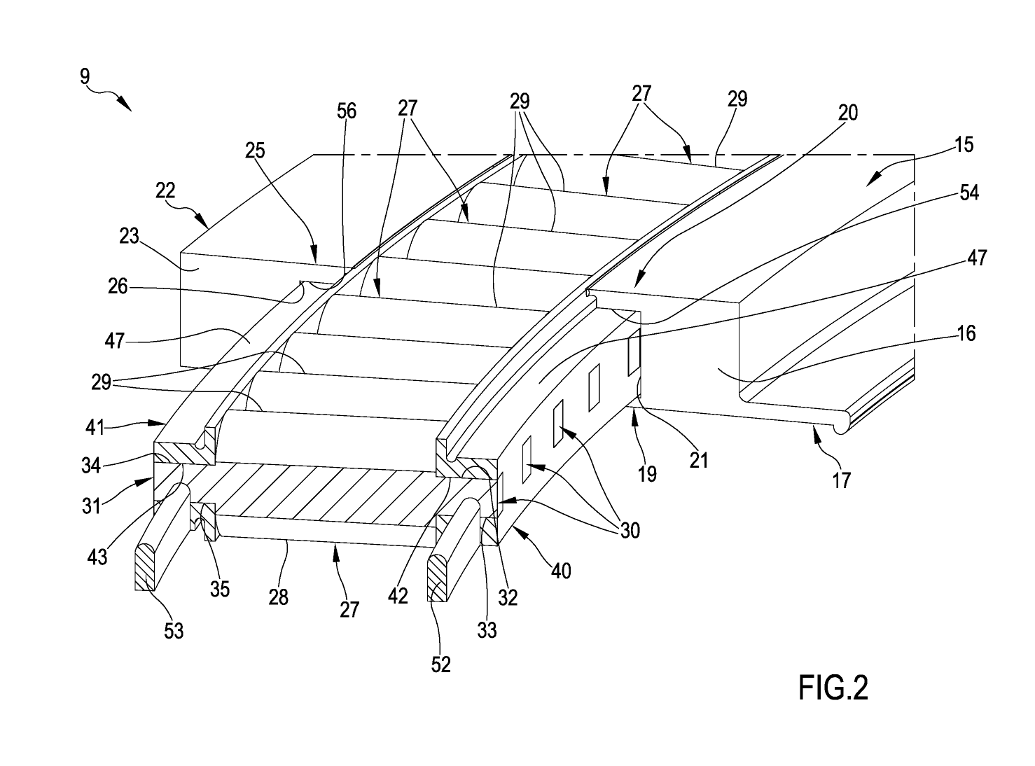

The rotor bladed rings 9 and the stator bladed rings 14 are structurally similar to each other, so that only the embodiments and variants of the rotor bladed rings 9 will be described in detail below (FIGS. 2-6).

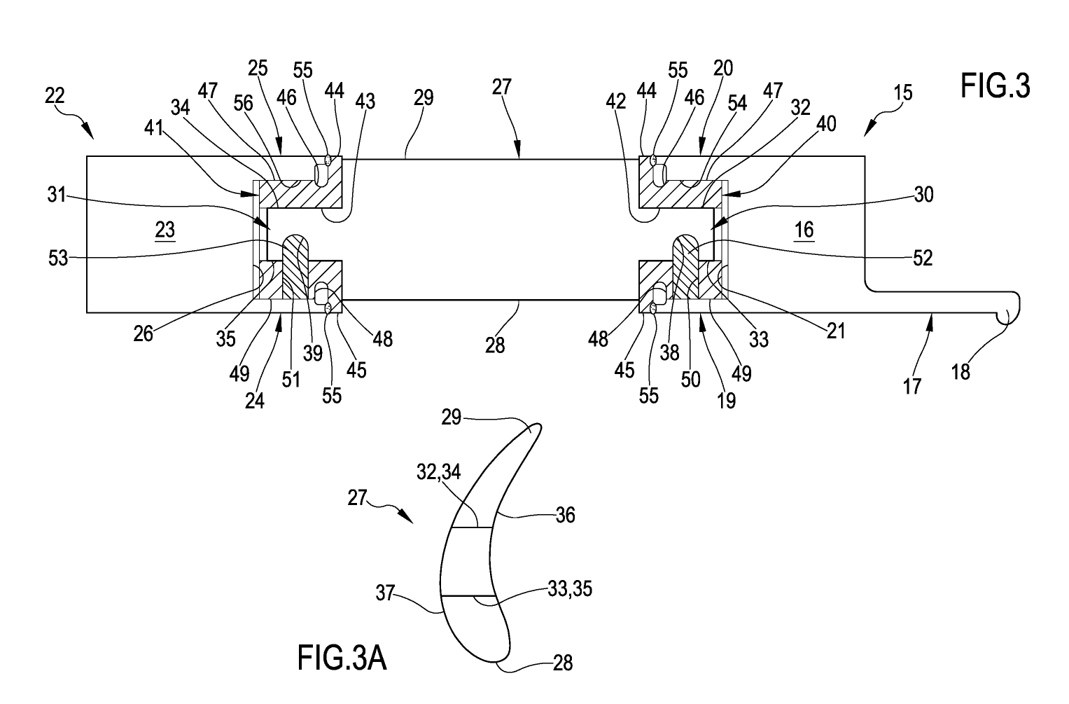

With reference to FIGS. 2, 3 and 3A, the bladed ring 9 comprises a first support ring 15 made, for example, by forging, and intended to be anchored to the front face 7 of the rotor disk 6.

FIG. 3 shows a cross section, in an axial plane, of the first support ring 15. As can be noted, the first support ring 15 has a first annular central body 16, which, in the aforesaid cross section, is rectangular or square and axially extending from which there is, on one side, an annular anchorage appendage 17 having an anchorage end 18 intended to be constrained to the rotor disk 6 and, on the other side, a radially inner annular portion 19 and a radially outer annular portion 20. The radially inner annular portion 19 and the radially outer annular portion 20 are coaxial and radially spaced from each other and delimit, together with the first annular central body 16, a first annular recess 21.

The bladed ring 9 comprises a second support ring 22 made, for example, by forging. FIG. 3 shows the cross section, in an axial plane, of the second support ring 22. As can be noted, the second support ring 22 has a second annular body 23, which in the aforesaid cross section is rectangular or square and axially extending from which, on a same side, there is a radially inner annular portion 24 and a radially outer annular portion 25. The radially inner annular portion 24 and the radially outer annular portion 25 are coaxial and radially spaced from each other and delimit, together with the second annular body 23, a second annular recess 26.

The bladed ring 9 comprises a plurality of blades 27 with an aerodynamic profile which extend between the first and second support rings 15, 22. The first and second support rings 15, 22 are coaxial and axially spaced from one another. The blades 27 can be formed by extrusion. In one embodiment, the blades 27 are obtained from an extruded rod having a cross section with an aerodynamic profile (airfoil profile), which is cut into pieces.

Each blade 27 has a leading edge 28 and a trailing edge 29 parallel to the central axis “X-X” of the bladed ring 9. Since the turbomachine 1 illustrated is a centrifugal radial turbine, in which the working fluid moves radially outward, the leading edge 28 of every blade 27 is turned radially inward, i.e. towards said central axis “X-X”, and the trailing edge 29 is turned radially outward.

The blades 27 are disposed equidistant from the central axis “X-X” and circumferentially spaced from one another by a constant distance.

Every blade 27 has a first end 30 and a second end 31 axially opposed and shaped like a sort of peg for connecting with the first and second support rings 15, 22.

The first and second ends 30, 31 have a different shape relative to the profile of the same blade, and in particular they have a non-circular cross section (in a plane orthogonal to the central axis “X-X”). In the embodiment of FIGS. 2, 3 and 3A, the first and second ends 30, 31 have two parallel, flat opposing surfaces 32, 33, 34, 35 and the remaining two surfaces 36, 37 are shaped respectively as the intrados 36 and extrados 37 of the blade 27. In particular, the first end 30 has a first radially outer coupling surface 32 and a first radially inner coupling surface 33. The second end has a second radially outer coupling surface 34 and a second radially inner coupling surface 35.

Each of said first ends 30 further has a first seat 38 formed in the first radially inner coupling surface 33 and each of the second ends 31 has a second seat 39 formed in the second radially inner coupling surface 35.

The connection between each blade 27 and the first and second support rings 15, 22 is made by interposing a first connecting ring 40 and a second connecting ring 41. The first ends 30 of the blades 27 are joined directly to the first connecting ring 40, which is in turn fixed to the first support ring 15. The second ends 31 of the blades 27 are joined directly to the second connecting ring 41, which is in turn fixed to the second support ring 15.

The blades 27 are therefore not directly connected to the first and second support rings 15, 22. The first and second connecting rings 40, 41 are made, for example, by forging.

The first connecting ring 40 comprises a plurality of first through slots 42 (the same number as the blades 27) which extend axially. Analogously, the second connecting ring 41 comprises a plurality of second through slots 43 (the same number as the blades 27) which extend axially. As may be seen in FIG. 2, the first and second slots 42, 43 are distributed around the central axis “X-X” with a constant distance between them. Each of the first and second slots 42, 43 is of a shaped mating that of the first or second ends 30, 31.

The first and second connecting rings 40, 41 are symmetric relative to a middle plane of the blades 27 orthogonal to the central axis “X-X”.

In the embodiment of FIG. 2, each of said first and second connecting rings 40, 41 has a main body through which the first and second slots 42, 43 are formed. A first peripheral edge 44 extends radially outward from the main body and a second peripheral edge 45 extends radially inward therefrom. A first annular groove 46 is formed on a radially outer centring surface 47 of the main body and extends alongside the first peripheral edge 44. A second annular groove 48 is formed on a radially inner surface 49 of the main body and extends alongside the second peripheral edge 45.

Each of said first and second connecting rings 40, 41 has a plurality of first/second radial through cavities 50, 51, each open into one of the first/second slots 42, 43. The first/second radial through cavities 50, 51 are formed in a radially inner portion of the first/second connecting rings 40, 41. The first/second radial through cavities 50, 51 thus open onto the radially inner surface 49 respectively of the first connecting ring 40 and of the second connecting ring 41.

In the embodiment illustrated in FIGS. 2 and 3, the first/second radial through cavities 50, 51 are part of a respective first/second circumferential cavity formed in the radially inner surface 49.

In a variant embodiment, not illustrated, each of the connecting rings 40, 41 can be made in sections, i.e. made up of a plurality of arched sectors placed circumferentially adjacent to one another.

The bladed ring 9 of FIGS. 2 and 3 further comprises a first and a second stop element 52, 53 consisting of locking rings which are inserted into the aforesaid first/second circumferential cavities and into the first/second seats 38, 48, as will be described in detail further below. Said locking rings 52, 53 are coaxial with the central axis “X-X”.

In accordance with the method for manufacturing bladed rings of the present invention and with reference to the embodiment of FIGS. 2, 3 and 3A, the first support ring 15, second support ring 16, blades 27, first connecting ring 40 and second connecting ring 41 are prepared in such a way as to already take on their final form in the bladed ring 9 they will form.

The first end 30 of every blade 27 is axially inserted into a respective first slot 42 until a surface of the blade 27 situated alongside said first end 30 is brought against a surface of the first connecting ring 40 onto which the first slots 42 open.

In this position, the first seat 38 of the first end 30 is radially aligned with the first radial through cavity 50 that opens into said first slot 42.

The blades 27 are then fixed to the first connecting ring 40 by radially inserting the first locking ring 52 through the first radial through cavities 50 and inside the first seats 38. Said insertion is preferably carried out by forcing the first ring 52 by interference into the first radial through cavities 50 and inside the first seats 38. The first locking ring 52 can consist of caulking material which is driven inside said first radial through cavities 50 and inside said first seats 38 or of a Seeger-type open-ended ring.

By means of this radial insertion, the first radially outer coupling surface 32 of the first end 30 is pushed radially outward and retained against a coupling surface of the first slot 42.

Analogously, the second end 31 of every blade 27 is axially inserted into a respective second slot 43 until a surface of the blade 27 situated alongside said second end 31 is brought against a surface of the second connecting ring 41 onto which the second slots 42 open. In this position, the second seat 39 of the second end 31 is radially aligned with the second radial through cavity 51 that opens into said second slot 43.

The blades 27 are then fixed to the second connecting ring 41 by radially inserting the second locking ring 53, in a manner similar to what was done with the first locking ring 52, through the second radial through cavities 51 and inside the second seats 39. By means of this radial insertion radial, the second radially outer coupling surface 34 of the second end 31 is pushed radially outward and retained against a coupling surface of the second slot 43.

The assembly formed by the first connecting ring 40, the second connecting ring 41 and the blades 27 interposed between them is subsequently joined to the first support ring 15 and second support ring 22.

For this purpose, the first connecting ring 40 is axially inserted into the first annular recess 21 of the first support ring 15 until bringing the first and second peripheral edges 44, 45 against axial ends of the radially inner annular portion 19 and radially outer annular portion 20, respectively. The radially outer centring surface 47 and radially inner surface 49 of the first connecting ring 40 lie in contact with inner surfaces of the first annular recess 21. In particular, the radially outer surface 47 lies in contact with a first radially inner circumferential abutment surface 54 of the radially outer annular portion 20 of the first support ring 15.

The radially inner annular portion 19 of the first support ring 15 is superimposed on the radially inner surface 49 of the first connecting ring 40 and in this manner closes the first radial through cavities 50 and radially locks the first locking ring 52 housed therein.

Said first and second peripheral edges 44, 45 of the first connecting ring 40 are fixed to the axial ends of the radially inner annular portion 19 and radially outer annular portion 20 of the first support ring 15 by performing localized welds 55 (continuous along the circumferential extent or intermittent or spot welds) by laser or friction stir welding (FSW).

The second connecting ring 41 is axially inserted into the second annular recess 26 of the second support ring 22 until bringing the first and second peripheral edges 44, 45 against axial ends of the radially inner annular portion 24 and radially outer annular portion 25, respectively. The radially outer centring surface 47 and radially inner surface 49 of the second connecting ring 41 lie in contact with inner surfaces of the second annular recess 21.

In particular, the radially outer surface 47 lies in contact with a second radially inner circumferential abutment surface 56 of the radially outer annular portion 20 of the first support ring 15.

The radially inner annular portion 19 of the second support ring 22 is superimposed on the radially inner surface 49 of the second connecting ring 41, closes the second radial through cavities 51 and radially locks the second locking ring 53 housed therein.

Said first and second peripheral edges 44, 45 of the second connecting ring 41 are also fixed to the axial ends of the radially inner annular portion 24 and radially outer annular portion 25 of the second support ring 22 by performing respective localized welds 55 (continuous along the circumferential extent or intermittent or spot welds) by laser or friction stir welding (FSW).

The radially outer centring surface 47 of the first and second connecting rings 40, 41, together with the first and second radially inner circumferential abutment surfaces 54, 56 of the first and second support rings 15, 22 define centring surfaces of the connecting rings 40, 41 and of the blades 27 relative to said support rings 15, 22. Since the bladed ring 9 illustrated in FIGS. 2, 3 and 3A is a rotor, during the rotation thereof and by virtue of the centrifugal force, the support rings 40, 41 expand radially and rest against the respective support rings 15, 22 on said first and second radially inner circumferential abutment surfaces 54, 56.

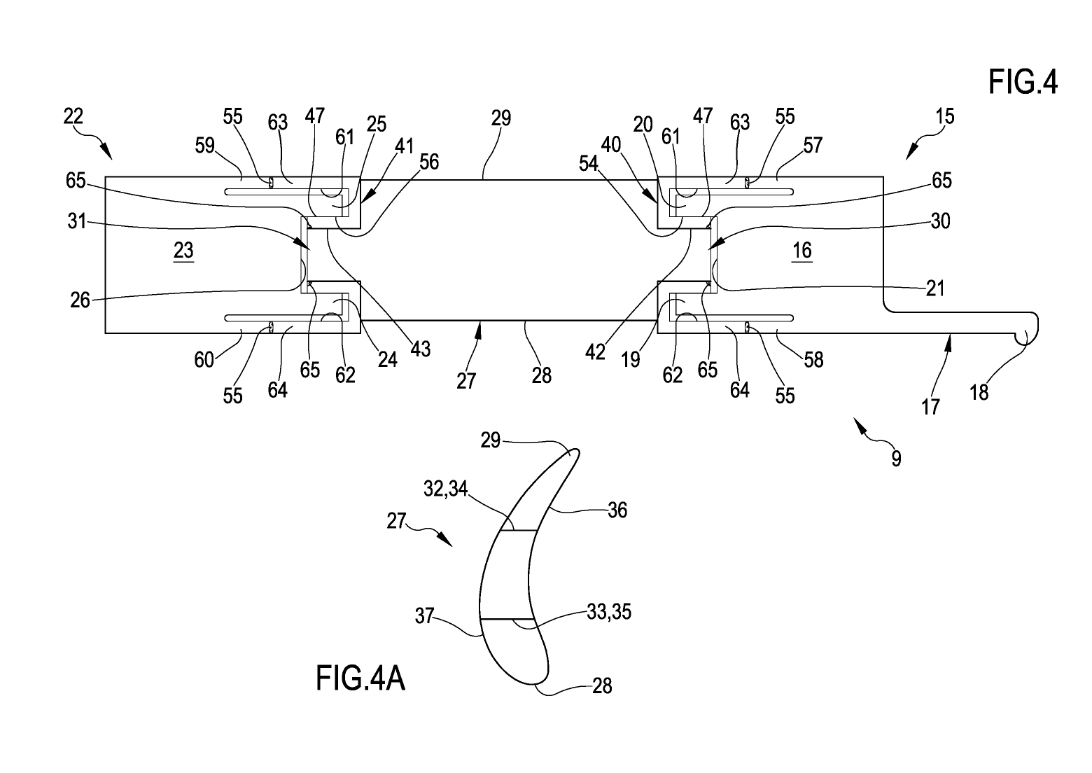

FIGS. 4 and 4A illustrate a different embodiment of the bladed ring 9, wherein the connection between the connecting rings 40, 41 and blades 27 is also made by means of localized welds. In FIGS. 4 and 4A, the reference numbers of the parts in common with the embodiment of FIGS. 2, 3 and 3A are the same.

The first support ring 15, in addition to the radially inner annular portion 19 and the radially outer annular portion 20 which delimit the first annular recess 21, has a radially outer annular appendage 57, which projects from the central body 16 and externally surrounds the radially outer annular portion 20, and a radially inner annular appendage 58, which projects from the central body 16 and extends internally relative to the radially inner annular portion 19. The radially outer annular appendage 57 and radially inner annular appendage 58 are radially spaced from the respective radially inner/outer annular portions 19, 20 and have a lesser axial extent than the latter.

Similarly, the second support ring 22, in addition to the radially inner annular portion 24 and the radially outer annular portion 25 which delimit the second annular recess 26, has a radially outer annular appendage 59, which projects from the central body 23 and externally surrounds the radially outer annular portion 25, and a radially inner annular appendage 60, which projects from the central body 23 and extends internally relative to the radially inner annular portion 24. The radially outer annular appendage 59 and radially inner annular appendage 60 are radially spaced from the respective radially inner/outer annular portions 24, 25 and have a lesser axial extent than the latter.

The first locking ring 40 and second locking ring 41 are formed from metal sheets or by calendaring of rings. The first and second slots 42, 43 are first made by perforating the sheets in profile by laser cutting, water-jet cutting or electrical discharge machining.

The first locking ring 40 and second locking ring 41 are identical to each other.

Therefore, only the first locking ring 40 will be described below.

As can be noted from FIG. 4, the first locking ring 40 has a much smaller cross-section thickness than the support rings 15, 22.

The first locking ring 40, in addition to the first slots 42, delimits a first annular seat 61 and a second annular seat 62 which are concentric with each other. The first annular seat 61 is radially external to the plurality of first slots 42 and the second annular seat 62 is radially internal to said plurality of first slots 42. The cross section of the first locking ring 40, as illustrated in FIG. 4, has a central portion which internally delimits one of the first slots 42. The first annular seat 61 and second annular seat 62 are visible, respectively, in a radially outer and radially inner position. The first annular seat 61 is delimited by said central portion and a radially outer tubular body 63 which extends parallel to the central portion. The second annular seat 62 is delimited by said central portion and by a radially inner tubular body 64 which extends parallel to the central portion.

The blades 27 of FIGS. 4 and 4A have a structure that is wholly similar to that of the blades 27 illustrated in FIGS. 2, 3 and 3A.

The first end 30 of every blade 27 is inserted into one of the first slots 42 and is joined to the first connecting ring 40 by performing localized welds 65 by laser or friction stir welding (FSW). The welds are performed in terminal portions of the first slot 42 and the first end 30. In a wholly analogous manner, the second end 31 of every blade 27 is inserted into one of the second slots 43 of the second connecting ring 41 and is joined to said second connecting ring 41 by performing localized welds 65.

At this point, the central portion of the first connecting ring 40 is axially inserted into the first annular recess 21 of the first support ring 15 until bringing the radially outer annular appendage 57 in proximity to or in contact with the radially outer tubular body 63 and the radially inner annular appendage 58 in proximity to or in contact with the radially inner tubular body 64 of the first connecting ring 40.

In a similar manner, the central portion of the second connecting ring 41 is axially inserted into the second annular recess 26 of the second support ring 22 until bringing the radially outer annular appendage 59 in proximity to or in contact with the radially outer tubular body 63 and the radially inner annular appendage 60 in proximity to or in contact with the radially inner tubular body 64 of the second connecting ring 41.

Localized butt welds 55 (laser or FSW) are performed between every radially outer annular appendage 57, 59 and the respective radially outer tubular body 63 and between every radially inner annular appendage 58, 60 and the respective radially inner tubular body 64.

The localized welds 65 between the blades 27 and the first and second connecting rings 40, 41 remain internal and concealed within the support bodies 15, 22.

The first and second radially inner circumferential abutment surfaces 54, 56 of the first and second support rings 15, 22 are defined on the central portions.

The radially outer centring surface 47 of the first and second connecting rings 40, 41 together with the first and second radially inner circumferential abutment surfaces 54, 56 of the first and second support rings 15, 22 define centring surfaces of the connecting rings 40, 41 and the blades 27 relative to said support rings 15, 22.

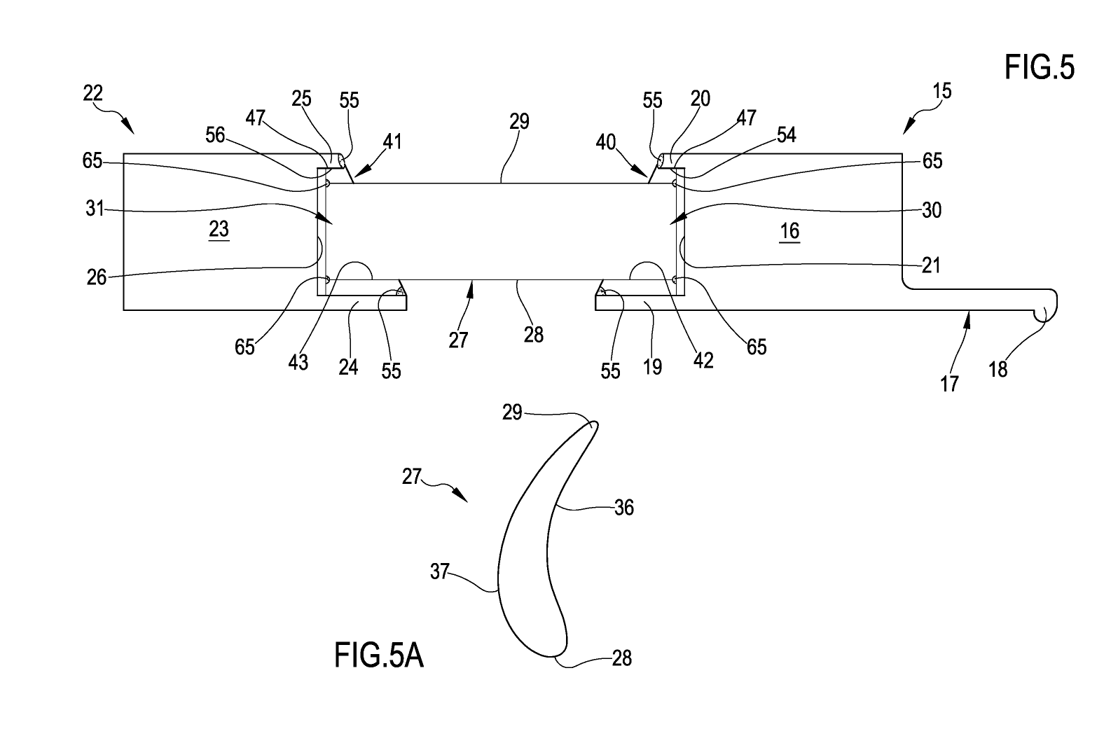

FIG. 5 illustrates a variant of the embodiment of FIG. 4, wherein the connection between the connecting rings 40, 41 and the blades 27 is made in the same manner, i.e. by means of localized welds 65. In FIGS. 5 and 5A, the reference numbers of the parts in common with the embodiments of FIGS. 2, 3, 3A, 4 and 4A are the same.

The first and second support rings 15, 22 are not provided with the annular appendages 57, 58, 59, 60 and are geometrically more similar to the embodiment of FIGS. 2, 3 and 3A.

As can be noted, the radially inner annular portions 19, 24 of the first and second support rings 15, 22 are axially longer than the radially outer annular portions 20, 25.

The first and second ends 30, 31 have the same shape as the profile of the blade 27 to which they belong. Each of the first and second slots 42, 43 therefore has a shape corresponding to the complete profile of the blade 27. In this variant embodiment as well, the first end 30 of every blade 27 is inserted into one of the first slots 42 and is joined to the first connecting ring 40 by performing localized welds 65 by laser or friction stir welding. The welds are performed in the terminal portions of the first slot 42 and the first end 30. In a wholly analogous manner, the second end 31 of every blade 27 is inserted into one of the second slots 43 and is joined to the second connecting ring 41 by performing localized welds 65. The localized welds 65 between the blades 27 and the first and second connecting ring 40, 41 remain internal and concealed in the support bodies 15, 22.

The first and the second connecting ring 40, 41 are symmetrical. As can be noted, a surface of each connecting ring 40, 41, turned towards the other connecting ring 41, 40, is in the shape of a truncated cone so as to delimit a divergent radial (flaring) passage for the working fluid.

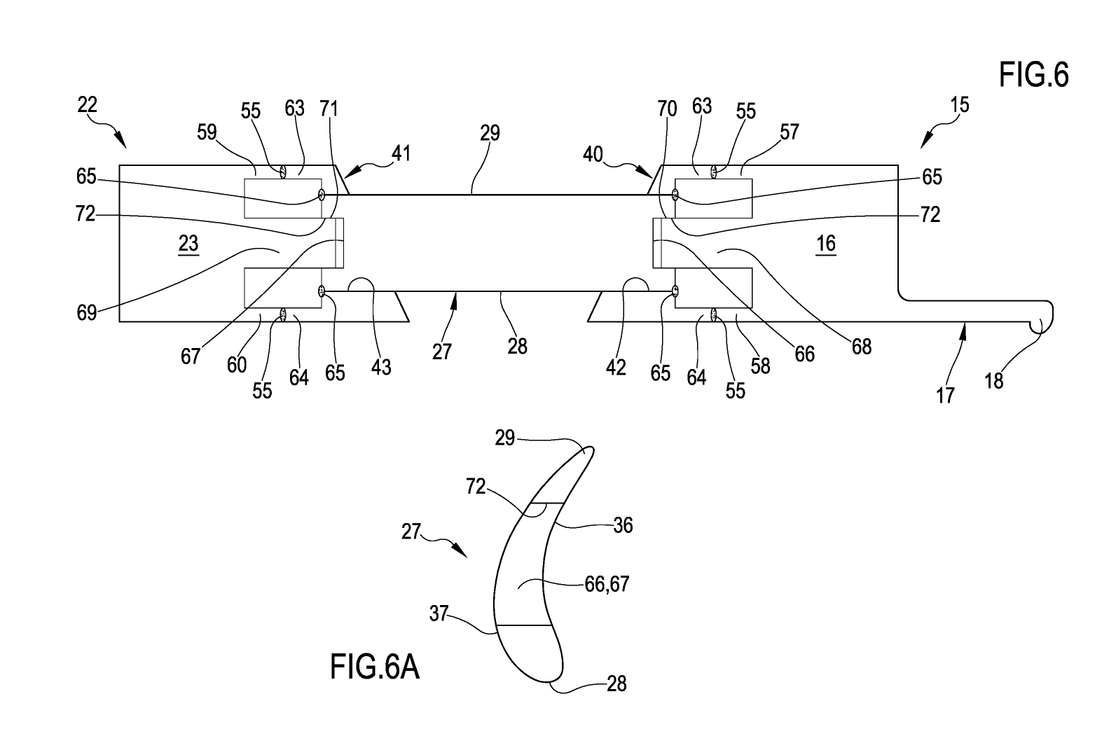

The localized welds 55 placed between the first/second support ring 15, 22 and the respective first/second connecting rings 40, 41 are located at the ends of the radially inner annular portions 19, 24 and radially outer annular portions 20, 25. FIGS. 6 and 6A illustrate a further variant which has features of the embodiment of FIGS. 4, 4A and the embodiment of FIGS. 5 and 5A.

The first and second connecting rings 40, 41 are connected respectively to the first and second support rings 15, 22 by means of localized welds 55 (laser or FSW) performed between every radially outer appendage 57, 59 and the respective radially outer tubular body 63 and between every radially inner annular appendage 58, 60 and the respective radially inner tubular body 64, as in the embodiment of FIGS. 4 and 4A.

The first and second ends 30, 31 have the same shape as the profile of the blade 27 to which they belong and each of the first and second slots 42, 43 therefore has a shape corresponding to the complete profile of the blade 27, as in the embodiment of FIGS. 5 and 5A.

Moreover, unlike the previously described embodiments, the first and second ends 30, 31 of every blade 27 have, respectively, a first and a second recess 66, 67.

The first support ring 15, in the place of the first annular recess 21, has a first annular projection 68. The second support ring 22, in the place of the second annular recess 26, has a second annular projection 69. The first annular projection 68 has a first radially outer circumferential abutment surface 70. The second annular projection 69 has a radially outer circumferential abutment surface 71.

The first annular projection 68 is axially inserted into the first recess 66 of every blade 27 and, when the bladed ring 9 rotates, the first radially outer circumferential abutment surface 70 rests, by virtue of the centrifugal force, against a radially inner centring surface 72 of the first recess 66. The second annular projection 69 is axially inserted into the second recess 67 of every blade 27 and, when the bladed ring 9 rotates, the second radially outer circumferential abutment surface 71 rests against a radially inner centring surface 72 of the second recess 66.

1. Method for manufacturing bladed rings for radial turbomachines, comprising:
preparing a first support ring;
preparing a second support ring;
preparing a plurality of blades;
preparing a first connecting ring or first connecting arched sectors;
preparing a second connecting ring or second connecting arched sectors;
assembling the first support ring with the second support ring, with the plurality of blades, with the first connecting ring, or with the first connecting arched sectors, and with the second connecting ring, or with the second connecting arched sectors, so as to make a bladed ring comprising the first and second support rings coaxial and axially spaced one from the other and the plurality of blades disposed equidistant from a central axis and interposed between the first and second support rings, wherein the blades have a leading edge substantially parallel to the central axis;
wherein assembling comprises:
stably joining a first end of each blade to the first connecting ring, or to one of the first connecting arched sectors; stably joining a second end of each blade to the second connecting ring, or to one of the second connecting arched sectors;
fixing the first connecting ring, or the first connecting arched sectors, to the first support ring; fixing the second connecting ring, or the second connecting arched sectors, to the second support ring;
wherein stably joining comprises:
performing localized welds placed between the first ends ends and the first connecting ring, or the first connecting arched sectors, and placed between the second ends and the second connecting ring, or the second connecting arched sectors; or
interposing at least a first stop element between the first ends and the first connecting ring, or the first connecting arched sectors, and at least a second stop element between the second ends and the second connecting ring, or the second connecting arched sectors;
wherein said the first support ring, second support ring, plurality of blades, first connecting ring, or first connecting arched sectors, second connecting ring, or second connecting arched sectors, are all finished elements before assembling, meaning that they present their final geometry and they do not need further machining and/or permanent plastic deformations during and/or after the assembling.

2. Method according to claim 1, wherein stably joining comprises: axially inserting the first ends in first slots formed in the first connecting ring, or in the first connecting arched sectors, to radially align first radial through cavities formed in the first connecting ring, or in the first connecting arched sectors, and open into the first slots, with first seats formed in the first ends;
radially inserting said at least a first stop element into the first radial through cavities and into the first seats in such a way as to prevent axial displacements;
axially inserting the second ends into second slots formed in the second connecting ring, or in the second connecting arched sectors, to radially align second radial through cavities formed in the second connecting ring, or in the second connecting arched sectors, and open into the second slots, with second seats formed in the second ends;
radially inserting the at least a second stop element into the second radial through cavities and into the second seats in such a way as to prevent axial displacements.

3. Method according to claim 2, wherein the first radial through cavities and the second radial through cavities open onto a radially inner surface respectively of the first connecting ring, or of the first connecting arched sectors, and of the second connecting ring, or of the second connecting arched sectors.

4. Method according to claim 2, wherein the at least a first stop element is a first locking ring and the at least a second stop element is a second locking ring and wherein the first radial through cavities delimit a first circumferential cavity housing the first locking ring and the second radial through cavities delimit a second circumferential cavity housing the second locking ring.

5. Method according to claim 2, wherein fixing comprises:
inserting axially and at least in part the first connecting ring, or the first connecting arched sectors, into a first groove formed in the first support ring to close the at least a first stop element in the first radial through cavities;
inserting axially and at least in part the second connecting ring, or the second connecting arched sectors, into a second groove formed in the second support ring to close said the at least a second stop element in the second radial through cavities.

6. Method according to claim 1, wherein stably joining comprises:
axially inserting the first ends into first slots formed in the first connecting ring, or in the first connecting arched sectors, and welding the first ends in the first slots;
axially inserting the second ends into second slots formed in the second connecting ring, or in the second connecting arched sectors, and welding the second ends in the second slots.

7. Method according to claim 1, comprising:
coupling a first radially inner/outer circumferential abutment surface of the first support ring with a radially outer/inner centring surface of the first connecting ring, or of the first connecting arched sectors, or belonging to the first ends of the blades;
coupling a second radially inner/outer circumferential abutment surface of the second support ring with a radially outer/inner centring surface of the second connecting ring, or of the second connecting arched sectors, or belonging to the second ends of the blades.

8. Method according to claim 7, wherein the first radial through cavities and the second radial through cavities open onto a radially inner surface respectively of the first connecting ring, or of the first connecting arched sectors, and of the second connecting ring, or of the second connecting arched sectors; and
wherein the radially outer centring surface of the first connecting ring, or of the first connecting arched sectors, and the radially outer centring surface of the second connecting ring, or of the second connecting arched sectors, are opposed to the radially inner surface respectively of the first connecting ring, or of the first connecting arched sectors, and of the second connecting ring, or of the second connecting arched sectors.

9. Method according to claim 2, wherein the first ends have a first radially outer coupling surface, and wherein the second ends have a second radially outer coupling surface; wherein radially inserting the at least a first stop element implies pushing the first coupling surface against a coupling surface of the first slot wherein radially inserting said the at least a second stop element implies pushing the second coupling surface against a coupling surface of the second slot.

10. Method according to claim 1, wherein the blades are made by extrusion.

11. Bladed ring for radial turbomachines, comprising:
a first support ring;
a second support ring coaxial with the first support ring and axially spaced from the first support ring;
a plurality of blades disposed equidistant from a central axis and interposed between the first support ring and second support ring, wherein the blades have a leading edge substantially parallel to the central axis;
a first connecting ring or first connecting arched sectors axially interposed between the first support ring and the blades;
a second connecting ring or second connecting arched sectors axially interposed between the second support ring and the blades;
wherein first ends of the blades are joined to the first connecting ring or to one of the first connecting arched sectors and second ends of the blades are joined to the second connecting ring or to one of the second connecting arched sectors by means of localized welds of the laser or friction stir welding type; or wherein the first ends of the blades are joined to the first connecting ring or to one of the first connecting arched sectors and the second ends of the blades are joined to the second connecting ring or to one of the second connecting arched sectors by means of at least a first stop element placed between the first ends and the first connecting ring or the first connecting arched sectors and at least a second stop element placed between the second ends and the second connecting ring or the second connecting arched sectors;
wherein the first connecting ring or the first connecting arched sectors is/are fixed to the first support ring and the second connecting ring or the second connecting arched sectors is/are fixed to the second support ring by means of localized welds of the laser or friction stir welding type.

12. Bladed ring according to claim 11, wherein the first connecting ring or the first connecting arched sectors has/have a plurality of first slots which extend axially; wherein the second connecting ring or the second connecting arched sectors has/have a plurality of second slots which extend axially; wherein the first ends of the blades are axially inserted into the first slots; wherein the second ends of the blades are axially inserted into the second slots.

13. Bladed ring according to claim 11, wherein the first connecting ring or the first connecting arched sectors has/have a plurality of first radial through cavities, each open into one of the first slots; wherein the second connecting ring or the second connecting arched sectors has/have a plurality of second radial through cavities each open into one of the second slots; wherein at least a first stop element is radially inserted into the first radial through cavities and into first seats formed in the first ends in such a way as to prevent axial displacements; wherein at least a second stop element is radially inserted into the second radial through cavities and into second seats formed in the second ends in such a way as to prevent axial displacements.

14. Bladed ring according to claim 13, wherein the at least a first stop element is a first locking ring, wherein the first radial through cavities together form a first circumferential cavity housing the first locking ring; wherein the at least a second stop element is a second locking ring, wherein the second radial through cavities together form a second circumferential cavity housing the second locking ring.

15. Bladed ring according to claim 14, wherein the first and second connecting rings are open-ended Seeger rings, or the first and second connecting rings are obtained from caulking material that is driven inside the first and second radial through cavities and inside said first and second seats.
